(19) United States
(12) Patent Application Publication
(10) Pub. No.: US 2015/0186813 A1
(43) Pub. Date: Jul. 2, 2015

(54) Product, system, and method for Operational Risk curve management

(71) Applicant: Jonathan Miles Collin Rosenoer, Larkspur, CA (US)

(72) Inventor: Jonathan Miles Collin Rosenoer, Larkspur, CA (US)

(21) Appl. No.: 14/141,624

(22) Filed: Dec. 27, 2013

(51) Int. Cl. G06Q 10/06; G06K 9/62; G06T 11/20

(52) U.S. Cl. CPC G06Q 10/0635; G06T 11/206; G06K 9/6202; G06T 2210/36

(57) ABSTRACT

A product, system, and method are provided to efficiently manage potential future operational risk exposure by means of curve analysis, scalable to accommodate Big Data, made tractable by utilization of power law distributions, such that operational risk is accessible and susceptible to proactive management, including, but not limited to, by utilization of benchmarking, economic trade-off and cost-benefit analysis, forecasting, and reporting.

### CROSS-REFERENCE TO RELATED APPLICATIONS

Not applicable.

### BACKGROUND OF THE INVENTION

1. Field of Invention The technology described herein relates generally to operational risk management, including, but not limited, to management of information technology risk and third party service provider risk.

2. Background of the Invention

Risk management refers to the process for identification, management, and control of the effect of uncertainty on objectives. A risk manager seeks to be prepared for future potential adverse movements of risk factors.

Operational risk (OR) is a newly defined and broad discipline that focuses on the risks posed by inadequate or failed technology, processes, human factors (people), or by external events. It can be subdivided by impact categories, idiosyncratically (e.g., by an individual business enterprise) or systemically (e.g., by industry). In the financial services domain, a commonly used taxonomy to describe the areas impacted by OR includes the following categories: Internal Fraud; External Fraud; Employment Practices and Workplace Safety; Clients, Products, and Business Practices; Damage to Physical Assets; Business Disruptions and System Failures; Transaction Capture, Execution, and Maintenance.

In order to forecast and efficiently manage potential future risk exposure in the field of OR, tools are needed to help managers understand future risk and support risk management analysis. This is needed because, due to inherent properties of complex systems (including incomprehensibility), many classes of disasters that previously were regarded as exceptional or “unexpected” are now proving a normal part of our existence.

As the OR management discipline has developed, a principal operative assumption is that future OR exposure is unknown but governed by known or knowable probability distributions. Evidence now suggests that this assumption is invalid and that OR is not governed by currently known or knowable probability distributions, particularly with regard to future potential extreme event (tail) exposures, and that such exposure is, therefore, subject to Knightian uncertainty.

Accordingly, it is desirable to provide products, systems, and methods that assist managers to understand uncertain potential future OR extreme event exposure and to manage it effectively and efficiently.

### BRIEF SUMMARY OF THE INVENTION

The invention refers to a product and method for OR curve management according to the claims. In particular, the invention is focused upon providing a scalable, extensible, and accessible way for managers to understand and manage future potential OR exposure by means of constructing a risk curve using incomplete information and in the absence of known or knowable probability distributions for OR.

In order to overcome the problems indicated in the previous section, the present invention is grounded on construction of a risk curve for OR by means of transforming historical OR incident data into a double logarithmic (log-log) plot, where it typically forms a power-law distribution. This distribution, which is scalable to accommodate Big Data, is fit for analytic purposes both because it captures the long tail behavior of OR in an easily accessible form, for operational managers and business executives, and because such distribution exhibits scale-free behavior that enables a range of analysis.

In a first aspect of the invention, there is provided a method for creating a risk curve by identifying at least one set of endogenous (“Internal”) or exogenous (“External”) OR incident data for at least one defined time period and plotting it on a graph using logarithmic scales on both the horizontal and vertical axes, with one axis corresponding to frequency value and another axis corresponding to severity value. In an embodiment, the identifying step isolates at least one set of Internal or External OR incident data for at least one finer level of resolution or granularity and plots it on a graph using said logarithmic scales in order to create a risk curve of finer resolution or granularity

In another aspect of the invention, the slopes of at least two of said Internal or External risk curves are calculated. In an embodiment, said slopes are compared and analyzed against each other.

In another aspect of the invention, there is provided a method for creating a benchmark risk curve by identifying at least one set of External OR incident data for at least one defined time period and plotting it on a graph using said logarithmic scales. In an embodiment, the slope of at least one said External risk curves is utilized as a benchmark and compared and analyzed with respect to the slope at least one said Internal risk curve.

In another aspect of the invention, there is provided a method for creating an economic trade-off or cost-benefit analysis in order to ascertain and provide for examination of potential efficient frontiers for OR management. In an embodiment, the shape of at least one OR risk curve is compared and analyzed with respect to changes in the composition of high-frequency—low severity OR incidents and/or low frequency—high severity OR incidents recorded in said curve caused by at least one change in risk management strategy or tactic. In an embodiment, an economic trade-off or cost-benefit analysis is undertaken for at least one change in said curve resulting from said change in risk management strategy or tactic. In an embodiment, a set of possible permutations of said curves are analyzed to determine which risk management strategy or tactic, or combination of said strategy or tactic, produces the best possible expected economic return (i.e., an efficient frontier).

In another aspect of the invention, there is provided a method for forecasting the severity of potential future extreme OR events by extending the distribution of at least one of said risk curves. In an embodiment, in order to forecast a potential future extreme event said distribution is extended at the tail beyond that described by the underpinning data set by means of utilizing the exponential decay rate that describes said risk curve. In an embodiment, at least one of said forecast severity values is examined by means of scenario analysis to ascertain the characteristics of a potential future extreme event that may generate such a severity value.

In another aspect of the invention, there is provided a method for rendering said risk curves in the form of static and/or animated volatility surfaces.

In another aspect of the invention, there is provided a product and system comprising computer program instructions and modules, which may also be implemented as a combination of software and one or more hardware devices, to execute said methods and associated embodiments of the present invention.

### BRIEF DESCRIPTION OF THE DRAWINGS

The accompanying drawings, which are incorporated in and form a part of this specification, illustrate embodiments of the invention and, together with the description, serve to explain the principles of the invention:

FIGS. 1-5 illustrate example depictions of risk curves and associated analytics in accordance with an embodiment of the present invention.

FIG. 1 is a graphical illustration of a risk curve constructed in accordance with an embodiment of the present invention.

FIG. 2 is a graphical illustration of two risk curves constructed from different sets of OR incident data in accordance with an embodiment of the present invention.

FIG. 3 is a graphical illustration of two risk curves constructed from the same set of OR incident data in accordance with an embodiment of the present invention wherein the first of said curves is transformed into the second of said curves in the course of an economic trade-off or cost-benefit analysis process.

FIG. 4 is a graphical illustration of a risk curve constructed in accordance with an embodiment of the present invention wherein said curve is extended along the frequency and severity axes beyond the data set represented by said curve in order to forecast potential future extreme event severity in accordance with an embodiment of the present invention.

FIG. 5 is a graphical illustration of the rendering of multiple risk curves in the form of a volatility surface in accordance with an embodiment of the present invention.

### BEST MODE FOR CARRYING OUT THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In a first aspect of the invention, there is provided a method for creating a risk curve for at least one aspect of OR by identifying at least one set of Internal or External OR incident data for such aspect over at least one defined time period and plotting it on a graph using logarithmic scales on both the horizontal and vertical axes, with one axis corresponding to frequency value and another axis corresponding to severity value. In an embodiment, the identifying step isolates at least one set of Internal or External OR incident data for at least one finer level of resolution or granularity for said aspect and plots it on a graph using said logarithmic scales in order to create a risk curve of finer resolution or granularity.

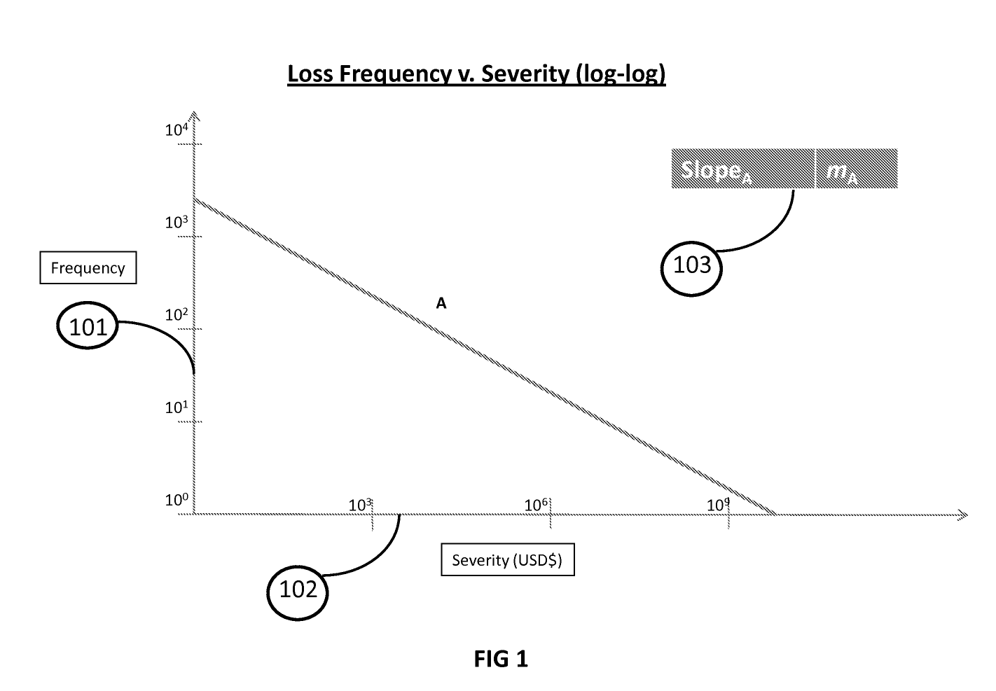

Reference is now made to FIG. 1, which is a graphical illustration of a risk curve constructed in accordance with an embodiment of the present invention. Reference numeral 101 illustrates that the y-axis measures frequency, while reference numeral 102 illustrates that the x-axis measures severity in units of U.S. dollars. Reference numeral 103 illustrates a tabular representation of the result of the step of calculating the slope (m) of the data represented in a log-log plot.

In another aspect of the invention, the slopes of at least two of said risk curves are calculated. In an embodiment, said slopes are compared and analyzed against each other.

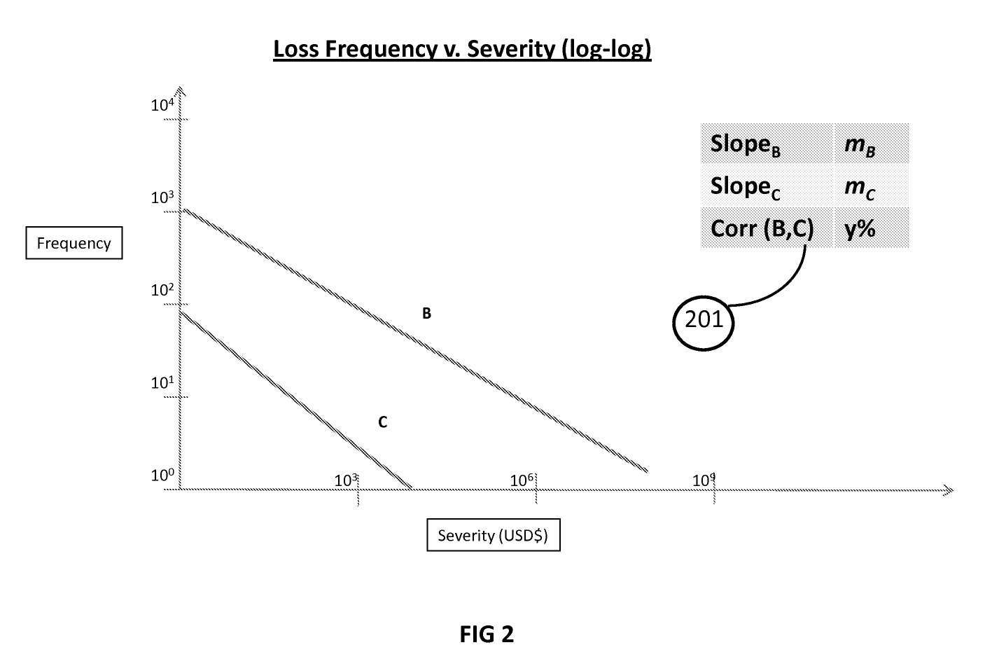

Reference is now made to FIG. 2, which is a graphical illustration of two risk curves constructed from different sets of OR incident data in accordance with an embodiment of the present invention. Reference numeral 201 is an illustration of a tabular representation of the result of the step of calculating the slope (m) of each set of data represented in a log-log plot and the further step of calculating the correlation between said slopes.

In another aspect of the invention, there is provided a method for creating an External benchmark risk curve by identifying at least one set of External OR incident data for at least one defined time period and plotting it on a graph using said logarithmic scales. In an embodiment, the slope of at least one said External benchmark risk curve is compared and analyzed with respect to the slope at least one said Internal risk curve.

In another aspect of the invention, there is provided a method for creating an economic trade-off or cost-benefit analysis in order to ascertain and provide for examination of potential efficient frontiers for OR management. In an embodiment, the shape of at least one said risk curve is compared and analyzed with respect to changes in the composition of high-frequency—low severity OR incidents and/or low frequency—high severity OR incidents recorded in said curve caused by at least one change in risk management strategy or tactic. In an embodiment, an economic trade-off or cost-benefit analysis is undertaken for at least one change in said curve resulting from said change in risk management strategy or tactic. In an embodiment, a set of possible permutations of said curves are analyzed to determine which risk management strategy or tactic, or combination of said strategy or tactic, produces the best possible expected economic return (“efficient frontier”).

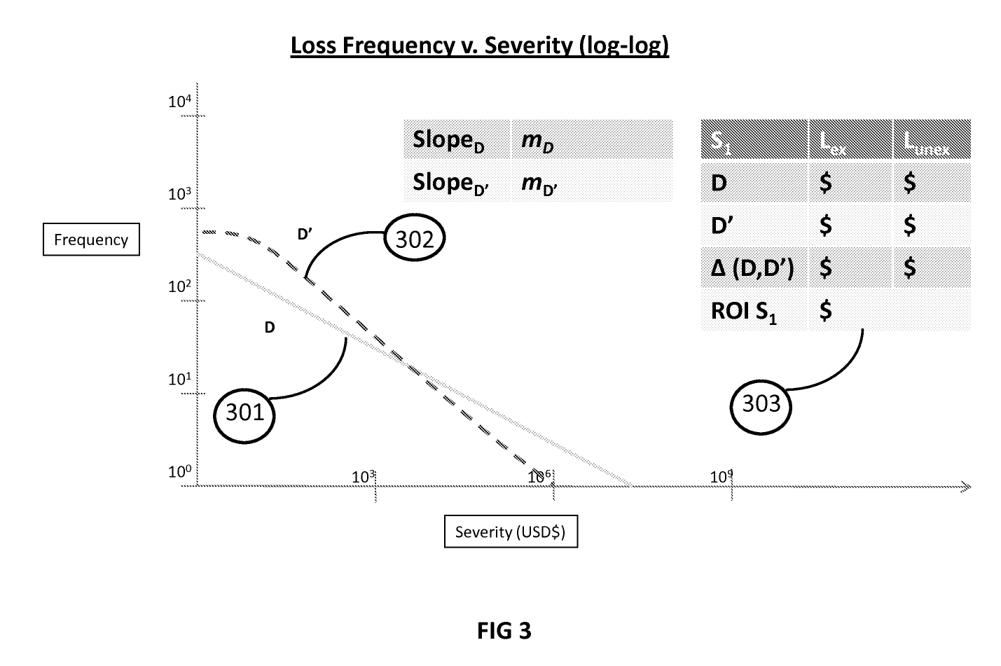

Reference is now made to FIG. 3, which is a graphical illustration of two of said risk curves constructed from the same set of OR incident data in accordance with an embodiment of the present invention wherein the first of said curves is transformed into the second of said curves in the course of an economic trade-off or cost-benefit analysis process and as caused by at least one change in risk management strategy or tactic. Reference numeral 301 illustrates a risk curve constructed in accordance with an embodiment of the present invention. Reference numeral 302 illustrates the resulting risk curve that has been transformed by steps taken in accordance with a change in risk management strategy or tactic (a scenario named S₁) in order to develop a potential efficient frontier for at least one aspect of OR by which the composition of high-frequency and low-severity losses—which may be termed “Expected Losses”—and/or low-frequency and high-severity losses—which may be termed “Unexpected Losses”—are changed in accordance with an embodiment of the present invention. Reference numeral 303 illustrates a tool for an economic trade-off or cost-benefit analysis in the form of the tabular representation of the result of the steps of calculating the total sum of Expected Losses and Unexpected losses for each of said original risk curve, D, and the said second curve that has been derived by means of said transformation, D′; the difference between the total sum of Expected Losses and/or Unexpected losses for each of said original risk curve, D, and said derived second risk curve, D′; and, the economic return resulting from said change in risk management strategy or tactic (named scenario S₁) that is reflected in the derived second curve, D′, in accordance with an embodiment of the present invention.

In another aspect of the invention, there is provided a method for forecasting the severity of potential future extreme OR events by extending the distribution of at least one of said risk curves. In an embodiment, said distribution is extended at the tail beyond that described by the underpinning Internal or External OR incident data set by means of utilizing the exponential decay rate that best describes said risk curve. In an embodiment, at least one of said forecast severity values is examined by means of scenario analysis to ascertain the characteristics of a future extreme event that may generate such severity value.

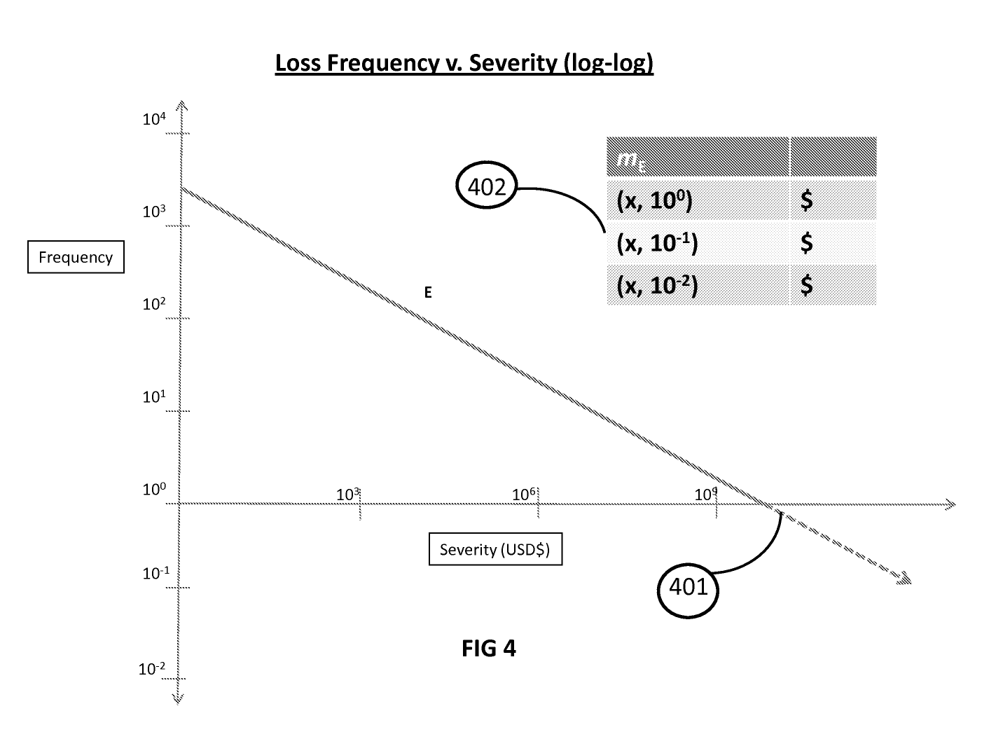

Reference is now made to FIG. 4, which is a graphical illustration of a risk curve constructed in accordance with an embodiment of the present invention wherein said curve is extended along the frequency and severity axes beyond the current data set represented by said curve in order to forecast severity in accordance with an embodiment of the present invention. Reference numeral 402 illustrates the result of extending said risk curve along said axes beyond the current data set represented by said curve in order to forecast severity in accordance with an embodiment of the present invention. Reference numeral 402 is an illustration of a tabular representation of the result of the steps of calculating the severity value of said curve corresponding to frequency values less than log10° in accordance with an embodiment of the present invention.

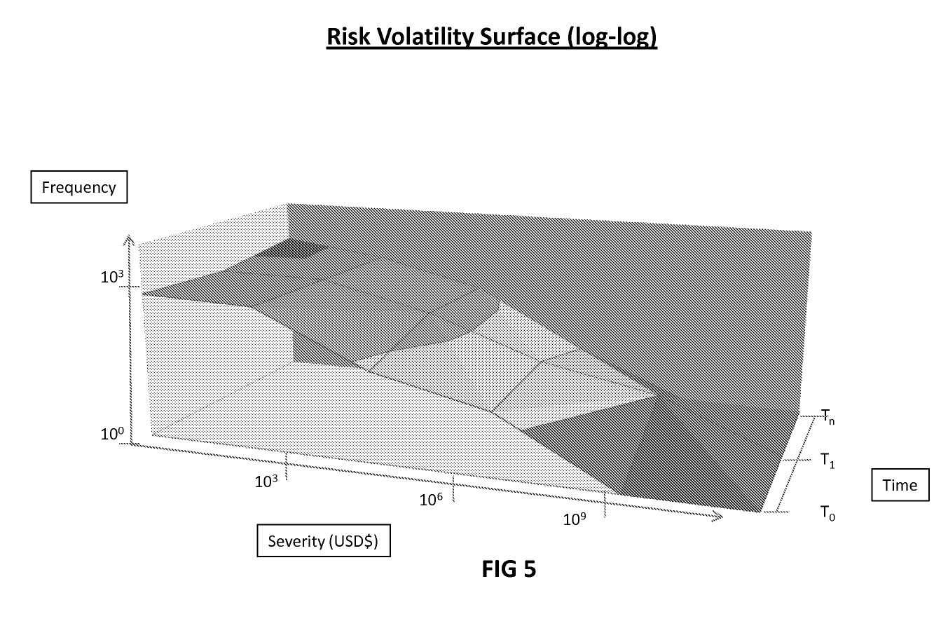

In another aspect of the invention, there is provided a method for rendering a volatility surface by means of utilizing one or more of said risk curves. In an embodiment, said volatility surface is composed across a time dimension. Reference is now made to FIG. 5, which is a graphical illustration of the rendering of said volatility surface by means of utilizing one or more of said risk curves. In an embodiment, at least one of said volatility surfaces is animated across a time dimension.

In an embodiment of the invention, there is provided a product and system for creating said risk curves, associated analysis, and volatility surfaces. Said product and system comprises a logic unit that contains a plurality of modules configured to functionally execute the necessary steps.

In particular, in said embodiment a data module connects by means of a communications channel to one or more inputs, including, but not limited to, Big Data inputs, that may be loaded manually by one or more users, or by electronic service request automatically extracted, transformed and loaded from one or more external databases or systems. Data entered into said data module is loaded into one or more analytic modules. In an embodiment, said analytic module includes one or more sets of business analytics, policies, or rules such that it is configured to enable one or more operations of said risk curve slope analysis, correlation, benchmarking, an economic trade-off or cost-benefit analysis, forecasting, scenario analysis, and static or animated volatility surface rendering. One or more results of said operations are transmitted by means of a communications channel to one or more rendering, display, and output modules. Said results and metadata identifying source data and operations is stored in one or more repository modules such that they can later be retrieved by a user or by said analytic module.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A processor-implemented method for creating a risk curve for at least one aspect of Operational Risk, said method comprising the steps of:
identifying at least one set of endogenous (“Internal”) or exogenous (“External”) Operational Risk (hereinafter, “OR” or “Operational Risk”) incident data for at least one aspect of OR over a defined time period; and,
plotting it on a graph using logarithmic scales on both the horizontal and vertical axes, with frequency value measured on one axis and severity value measured on the other axis.

2. The method according to claim 1, comprising the further steps of:
identifying at least one further set of said Internal or External OR incident data for at least one level of finer resolution or granularity of such data for said aspect; and,
plotting it on a graph using said logarithmic scales in order to create a risk curve of finer resolution or granularity.

3. The method according to claim 1, wherein the slopes of at least two of said risk curves are each calculated, compared, and analyzed.

4. The method according to claim 1, comprising the further steps of:
creating an External benchmark risk curve by identifying at least one set of External OR incident data for at least one aspect of OR over a defined time period; and,
plotting it on a graph using said logarithmic scales.

5. The method according to claims 1 through, and including, 4, wherein the slope of at least one said External benchmark risk curve is compared and analyzed with respect to the slope at least one said risk curve constructed from Internal OR incident data.

6. The method according to claim 1, wherein an economic trade-off or cost-benefit analysis is performed in order to ascertain and provide for examination of potential efficient frontiers for OR management by undertaking the further steps of:
simulating changes in the shape of at least one risk curve by changing the composition of high-frequency—low severity OR incident data and/or low frequency—high severity OR incident data recorded in said risk curve; and,
analyzing the impact of said changes in the context of economic trade-off or cost-benefit analysis and identification of potential efficient frontiers.

7. The method according to claim 1, wherein an economic trade-off or cost-benefit analysis is performed in order to ascertain and provide for examination of potential efficient frontiers for OR management by undertaking the further steps of:
simulating at least one change in risk management strategy or tactic that causes at least one change in the shape of said risk curve; and,
analyzing the impact of said changes in the context of economic trade-off or cost-benefit analysis and identification of potential efficient frontiers

8. The method according to claim 1, wherein the severity of potential future extreme OR events are forecast by undertaking the further steps of:
extending the distribution at the tail beyond that described by the underpinning OR incident data set of at least one of said risk curves; and,
measuring the intersection of said extended distribution at the axes corresponding both to frequency values for at least one frequency value and to severity values for at least one severity value.

9. The method according to claim 8, wherein the severity of said potential future extreme OR events is forecast by extending the distribution at the tail beyond that described by the underpinning Internal or External OR incident data set by means of utilizing the exponential decay rate that describes said risk curve.

10. The method according to claim 9, wherein at least one of said forecast severity values is examined by means of scenario analysis to ascertain the characteristics of a potential future extreme event that may generate such a severity value.

11. The method according to claims 1 through, and including, 10, wherein at least one of said risk curves is rendered as a risk volatility surface.

12. The method according to claim 11 wherein at least one of said volatility surfaces is animated across a time dimension.

13. A computer program product and system comprising program instructions for creating a risk curve according to claim 1.

14. The computer program product and system according to claim 13 comprising a separate set of computer instructions for calculating and comparing the slopes of at least two of said risk curves.

15. The computer program product and system according to claim 13 comprising a separate set of computer program instructions for obtaining Internal or External OR incident data to create at least one of said risk curves from at least one electronic service.

16. The computer program product and system according to claim 13 comprising a separate set of computer program instructions for simulating changes in the shape of at least one of said risk curves by changing the composition of high-frequency—low severity OR incidents and/or low frequency—high severity OR incidents recorded in said curves.

17. The computer program product and system according to claim 13 comprising a separate set of computer program instructions for undertaking an economic trade-off or cost-benefit analysis by simulating at least one change in the shape of said risk curve caused by at least one change in risk management strategy or tactic.

18. The computer program product and system according to claim 13 comprising a separate set of computer program instructions for forecasting the severity of potential future extreme OR events by extending the distribution at the tail beyond that described by the underpinning OR incident data set of at least one of said risk curves set by means of utilizing the exponential decay rate that describes said risk curve.

19. The computer program product and system according to claims 17 and 18 comprising a separate set of computer program instructions for forecasting the severity of potential future extreme OR events by extending the distribution at the tail beyond that described by the underpinning OR incident data set of at least one of said risk curves and measuring the intersection of said extended distribution at the axes corresponding both to frequency values for at least one frequency value and to severity values for at least one severity value.

20. The computer program product and system according to claims 13 through, and including, 19 comprising a separate set of computer program instructions for rendering at least one of said risk curves as a risk volatility surface.

21. The computer program product and system according to claim 20 comprising a separate set of computer program instructions for animating such rendered volatility surface across a time dimension.

22. A process for deploying computing infrastructure comprising integrating computer-readable code into a computing system, wherein said code in combination with said computing system performs the functions comprised in each of claims 13 through, and including, 20.
